(19) United States
(12) Patent Application Publication
(10) Pub. No.: US 2022/0114480 A1
(43) Pub. Date: Apr. 14, 2022

(54) APPARATUS AND METHOD FOR LABELING DATA

(71) Applicant: SAMSUNG SDS CO., LTD., Seoul (KR)

(72) Inventors: Ji Hoon KIM, Seoul (KR); Seung Ho SHIN, Seoul (KR); Se Won WOO, Seoul (KR)

(21) Appl. No.: 17/148,833

(22) Filed: Jan. 14, 2021

(30) Foreign Application Priority Data
Oct. 13, 2020 (KR) 10-2020-0131661

(51) Int. Cl. G06N 20/00; G06F 16/23

(52) U.S. Cl. CPC G06N 20/00; G06F 16/2379

(57) ABSTRACT

An apparatus for labeling data according to an embodiment of the present disclosure includes a data acquisitor that acquires a plurality of unlabeled data, a predicted label acquisitor that acquires predicted labels for the unlabeled data from a plurality of pre-training models pre-trained under different learning schemes, a sampler that selects a part of the unlabeled data as an initial review target, an initial review label acquisitor that acquires an initial review label for the part of the unlabeled data from a user, a model trainer that trains a labeling model based on the part of the unlabeled data, predicted labels for the part of the unlabeled data, and the initial review label, and a predictor that predicts labels of a part of the remaining unlabeled data excluding the part of the unlabeled data by applying the labeling model to the part of the remaining unlabeled data.

### CROSS-REFERENCE TO RELATED APPLICATION(S)

This application claims the benefit under 35 USC § 119(a) of Korean Patent Application No. 10-2020-0131661, filed on Oct. 13, 2020, in the Korean Intellectual Property Office, the entire disclosure of which is incorporated herein by reference for all purposes.

### BACKGROUND

### 1. Field

The disclosed embodiments relate to a technique for performing labeling on unlabeled data.

### 2. Description of Related Art

Deep learning-based supervised learning is a methodology that achieves high accuracy that surpasses humans in object classification, detection, and segmentation, and is used in various forms in most industries.

However, pre-labeled training data is required for supervised learning, and this is not an exception not only when the model is initially trained, but also when a pre-trained model is trained through transfer learning with respect to data in a new domain.

However, since most of the data existing in reality exist in an unlabeled state, there is a problem that labeling takes a lot of time. In addition, one of the factors that makes labeling difficult is that labeling should be performed by an expert with domain knowledge of the corresponding data.

### SUMMARY

The disclosed embodiments are intended to perform labeling on unlabeled data using prediction results of models pre-trained under different learning schemes.

A method for labeling data according to an embodiment disclosed is a method performed by a computing device including one or more processors and a memory for storing one or more programs executed by the one or more processors, the method including acquiring a plurality of unlabeled data, acquiring predicted labels for the unlabeled data from a plurality of pre-training models pre-trained under different learning schemes, selecting a part of the unlabeled data as an initial review target, acquiring an initial review label for the part of the unlabeled data from a user, training a labeling model based on the part of the unlabeled data, predicted labels for the part of the unlabeled data, and the initial review label, and predicting labels of a part of the remaining unlabeled data excluding the part of the unlabeled data by applying the labeling model to the part of the remaining unlabeled data.

The learning schemes may include at least one of domains in which the plurality of pre-training models are pre-trained and network structures of the plurality of pre-training models.

In the selecting, the part of the unlabeled data may be selected as the initial review target based on the predicted labels for the unlabeled data and a confidence corresponding to the predicted labels for the unlabeled data.

In the training the labeling model, the labeling model may be trained by using a label set composed of the predicted labels for the part of the unlabeled data and the initial review label as a ground truth for the part of the unlabeled data.

The training the labeling model may include calculating a loss function value based on an output value of the labeling model for the part of the unlabeled data and the label set, and updating one or more training parameters of the labeling model based on the loss function value.

In the predicting, for the part of the remaining unlabeled data, a prediction estimation label estimated to have been predicted by the plurality of pre-training models and a pseudo label predicted to be input by the user may be predicted.

A method for labeling data according to an additional embodiment may further include providing a pseudo label predicted to be input by the user for the part of the remaining unlabeled data to the user, and acquiring a review result for the pseudo label from the user.

In the training the labeling model, the labeling model may be further trained by using a label set composed of the predicted label for the part of the remaining unlabeled data and the review result as a ground truth for the part of the remaining unlabeled data.

The labeling model may be trained until the review result is acquired for all the remaining unlabeled data.

The types of the plurality of pre-training models and the labeling model may correspond to any one type in common among classification, detection, and segmentation.

An apparatus for labeling data according to an embodiment disclosed includes a data acquisitor that acquires a plurality of unlabeled data, a predicted label acquisitor that acquires predicted labels for the unlabeled data from a plurality of pre-training models pre-trained under different learning schemes, a sampler that selects a part of the unlabeled data as an initial review target, an initial review label acquisitor that acquires an initial review label for the part of the unlabeled data from a user, a model trainer that trains a labeling model based on the part of the unlabeled data, predicted labels for the part of the unlabeled data, and the initial review label, and a predictor that predicts labels of a part of the remaining unlabeled data excluding the part of the unlabeled data by applying the labeling model to the part of the remaining unlabeled data.

The learning schemes may include at least one of domains in which the plurality of pre-training models are pre-trained and network structures of the plurality of pre-training models.

The sampler may select the part of the unlabeled data as the initial review target based on the predicted labels for the unlabeled data and a confidence corresponding to the predicted labels for the unlabeled data.

The model trainer may train the labeling by using a label set composed of the predicted labels for the part of the unlabeled data and the initial review label as a ground truth for the part of the unlabeled data.

The model trainer may include a loss calculator that calculates a loss function value based on an output value of the labeling model for the part of unlabeled data and the label set, and an optimizer that updates one or more training parameters of the labeling model based on the loss function value.

The predictor, for the part of the remaining unlabeled data, may predict a prediction estimation label estimated to have been predicted by the plurality of pre-training models and a pseudo label predicted to be input by the user.

An apparatus for labeling data according to an additional embodiment may further include a model training reviewer that provides a pseudo label predicted to be input by the user for the part of the remaining unlabeled data to the user, and acquires a review result for the pseudo label from the user.

The model training may further train the labeling model by using a label set composed of the predicted label for the part of the remaining unlabeled data and the review result as a ground truth for the part of the remaining unlabeled data.

The labeling model may be trained until the review result is acquired for all the remaining unlabeled data.

The types of the plurality of pre-training models and the labeling model may correspond to any one type in common among classification, detection, and segmentation.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram for describing a system for labeling data according to an embodiment.

FIG. 2 is a block diagram for describing an apparatus for labeling data according to an embodiment.

FIG. 3 is a block diagram for describing in detail a model trainer according to an embodiment.

FIG. 4 is a block diagram for describing an apparatus for labeling data according to an additional embodiment.

FIG. 5 is a flowchart for describing a method for labeling data according to an embodiment.

FIG. 6 is a flowchart for describing step 550 in detail according to an embodiment.

FIG. 7 is a flowchart for describing a method for labeling data according to an additional embodiment.

FIG. 8 is a block diagram illustratively describing a computing environment including a computing device according to an embodiment.

### DETAILED DESCRIPTION

Hereinafter, a specific embodiment of the present invention will be described with reference to the drawings. The following detailed description is provided to aid in a comprehensive understanding of the methods, apparatus and/or systems described herein. However, this is only an example, and the disclosed embodiments are not limited thereto.

In describing the embodiments, when it is determined that a detailed description of related known technologies may unnecessarily obscure the subject matter of the disclosed embodiments, a detailed description thereof will be omitted. In addition, terms to be described later are terms defined in consideration of functions in the disclosed embodiments, which may vary according to the intention or custom of users or operators. Therefore, the definition should be made based on the contents throughout this specification. The terms used in the detailed description are only for describing embodiments, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, parts or combinations thereof, other than those described.

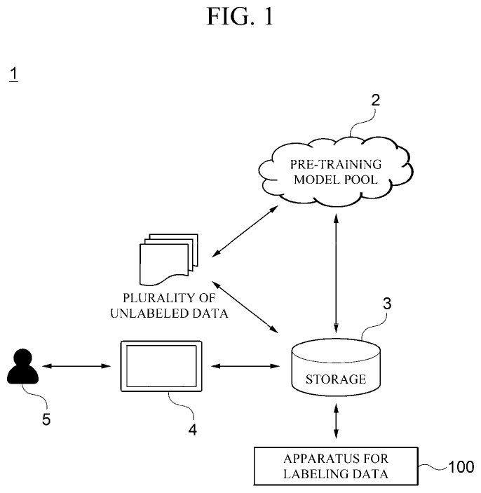

FIG. 1 is a block diagram for describing a system 1 for labeling data according to an embodiment.

Referring to FIG. 1, the system 1 for labeling data according to an embodiment includes a pre-training model pool 2, a storage 3, a display 4, and an apparatus 100 for labeling data.

The pre-training model pool (2) includes a plurality of pre-training models, and means an artificial neural network (ANN)-based model that has been pre-trained to predict a label of unlabeled data by receiving the unlabeled data.

Specifically, the pre-training model may correspond to any one type of classification that determines a class of an object contained in data, detection that detects a location of the object contained in the data, and segmentation that identifies both the class and location of the object contained in data.

Meanwhile, a format of the label predicted is also different depending on the type of the pre-training model and the labeling model below. For example, the format of each label according to the model type is as follows.

(1) A case where the pre-training model and the labeling model correspond to the classification type: Class obtained by classifying the data

(2) A case where the pre-training model and labeling model correspond to the detection type: Class obtained by being classified for one or more objects included in the data, and the center coordinates, width, and height of a bounding box indicating the location of each object

(3) A case where the pre-training model and labeling model correspond to the segmentation type: Class obtained by being classified for one or more objects included in the data, the center coordinates, width, and height of a bounding box indicating the location of each object, and the vertex coordinates of a polygon indicating a boundary of each object

Accordingly, the format of the predicted label by the following pre-training model, the format of the pseudo label predicted by the labeling model, the format of the initial review label of the user, and the format of the review result of the user may be also different depending on the model type described above. However, it should be noted that the format of each label described above according to the model type is exemplary, and depending on the embodiment, only a part of the format of each label may be selected from the elements described in the format described above, or additional elements not described in the format described above may be added thereto.

According to an embodiment, a plurality of pre-training models included in the pre-training model pool 2 may receive a plurality of unlabeled data to predict a label, and transmit and store prediction information including the predicted label to the storage 3.

In this case, when the plurality of pre-training models correspond to the classification type, the plurality of pre-training models may transmit and store the predicted label for each of the plurality of unlabeled data and confidence of each predicted label to the storage 3.

Meanwhile, when the plurality of pre-training models correspond to the detection or segmentation type, the plurality of pre-training models may transmit and store the predicted label for one or more objects included in each of the plurality of unlabeled data and confidence for each predicted label to the storage.

In this case, the ‘confidence’ means the probability of a predicted label compared to all predictable labels. For example, assume that one pre-training model determines that the all the predictable labels are ‘Jeju-do’, ‘Ulleung-do’, and ‘Dokdo’, and that the corresponding pre-training model determines that one unlabeled data is ‘Jeju-do’. In this case, if the probability of the ‘Jeju-do’ label is 0.7, the confidence of the corresponding pre-training model for the corresponding unlabeled data can be said to be 0.7.

The storage 3 may mean a storage space for storing prediction information including the predicted label transmitted from the pre-training model pool 2, but is not limited thereto, and may mean a storage space for storing the prediction information as well as the pre-training model pool itself, depending on the embodiment.

Although the storage 3 is illustrated as being a separate configuration from the apparatus 100 for labeling data in FIG. 1, the storage 3 may also mean a physical storage space provided in the apparatus 100 for labeling data.

In addition, the storage 3 may mean a physical recording medium that can be read by a computing device, but is not necessarily limited thereto, and may mean a virtual storage space provided by an external server that provides a cloud service depending on an embodiment.

The display 4 is a device used to provide information related to unlabeled data to the user 5 and to receive feedback from the user 5.

For example, the display 4 may be in the form of a smart phone, a tablet PC, a smart watch, a smart band, a personal computer, etc. In addition, any device that satisfies the definition described above is interpreted as belonging to the display 4.

According to an embodiment, the display 4 may exchange a series of signals for information exchange with the pre-training model pool 2, the storage 3, or the apparatus 100 for labeling data through a communication network.

In this case, the communication network may include the Internet, one or more local area networks, wide area networks, cellular networks, mobile networks, other types of networks, or combinations of these networks.

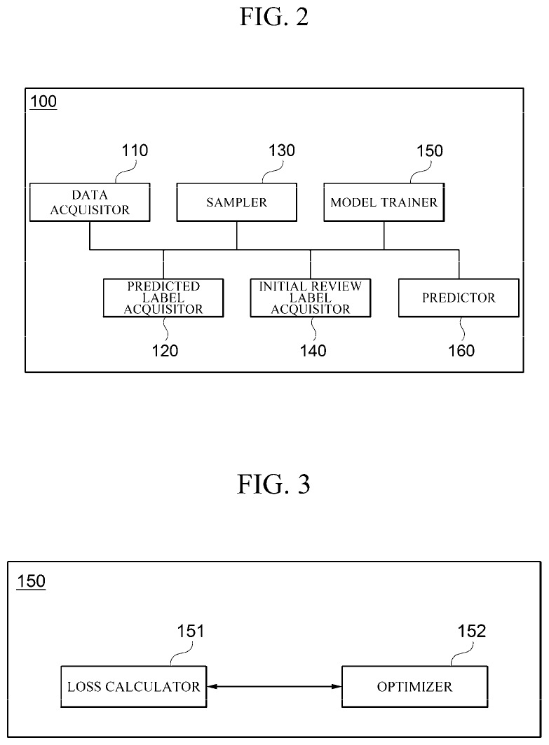

FIG. 2 is a block diagram for describing then apparatus 100 for labeling data according to an embodiment.

As illustrated, the apparatus 100 for labeling data according to an embodiment includes a data acquisitor 110, a predicted label acquisitor 120, a sampler 130, an initial review label acquisitor 140, a model trainer 150, and a predictor 160.

The data acquisitor 110 acquires a plurality of unlabeled data.

Specifically, the data acquisitor 110 may acquire a plurality of unlabeled data by accessing a separate storage space. For example, the data acquisitor 110 may acquire a plurality of unlabeled data stored in a separate storage space by declaring a command for accessing the corresponding separate storage space.

The predicted label acquisitor 120 acquires a predicted label for unlabeled data from a plurality of pre-training models pre-trained under different learning schemes.

In the following embodiments, the ‘learning schemes’ may include at least one of domains in which a plurality of pre-training models are pre-trained and network structures of a plurality of pre-training models.

For example, the predicted label acquisitor 120 may acquire predicted labels for a plurality of unlabeled data from a pre-training model A trained in a domain composed of three classes of ‘cat’, ‘dog’, and ‘rabbit’, a pre-training model B trained in a domain composed of four classes of ‘airplane’, ‘car’, ‘ship’, and ‘train’, and a pre-training model C trained in a domain composed of two classes of ‘apartment’ and ‘house’.

That is, in other words, the pre-training models A, B, and C were trained in different domains, but the labels of the plurality of unlabeled data can be predicted under a common domain (hereinafter referred to as ‘target domain’) in which labeling is to be actually performed.

Accordingly, the class determined by the pre-training model may be completely different from the actual unlabeled data itself or a target represented by the object contained therein, but regardless of this, by training the labeling model by paying attention only to what number of classes, among the classes in the domain in which each pre-training model is pre-trained, that each pre-training model determines either the unlabeled data itself or each object contained therein, accurate labels can be quickly generated without additional work.

According to an embodiment, the predicted label acquisitor 120 may acquire prediction information including the predicted labels predicted by a plurality of pre-training models and confidence for each predicted label. In this case, in acquiring the prediction information, the predicted label acquisitor 120 may directly acquire the prediction information from the plurality of pre-training models, but is not limited thereto, and may acquire the prediction information by accessing a storage space in which the prediction information is previously stored.

The sampler 130 selects a part of the unlabeled data as an initial review target.

Specifically, the sampler 130 may select the part of the unlabeled data as the initial review target based on the predicted label and confidence corresponding to the predicted label.

According to an embodiment, the sampler 130 may add a confidence value according to the predicted label predicted by each of the plurality of pre-training models for each unlabeled data without class classification.

Thereafter, the sampler 130 may sort the unlabeled data with the summed confidence value as a reference, and select the unlabeled data as an initial review target in descending order of a confidence value based on a preset ratio or a preset quantity.

For example, when the preset ratio is 10%, the sampler 130 may select data having a summed confidence value of the top 10% compared to all unlabeled data as an initial review target.

Meanwhile, as another example, when the total number of pieces of unlabeled data is 1000 and the preset quantity is 100, the sampler 130 may select 100 pieces of data in the order of the highest summed confidence value among all 1000 pieces of data.

The initial review label acquisitor 140 acquires an initial review label for the part of the unlabeled data selected as the initial review target from a user.

According to an embodiment, the initial review label acquisitor 140 may provide the part of the unlabeled data selected as the initial review target to the user through the display 4, and acquire the initial review label by receiving a selection as to which class among the classes of the target domain corresponds to the part of the unlabeled data selected from the user as an initial review target or each object included therein.

According to an embodiment, when a plurality of pre-training models correspond to the classification type, the initial review label acquisitor 140 may acquire the initial review label of the user for each of the plurality of unlabeled data.

Meanwhile, according to an embodiment, when the plurality of pre-training models correspond to the detection or segmentation type, the initial review label acquisitor 140 may acquire the initial review label of the user for one or more objects included in each of the plurality of unlabeled data.

The model trainer 150 trains the labeling model based on the part of the selected unlabeled data as the initial review target, the predicted label for the part of the selected unlabeled data as the initial review target, and the initial review label.

In the following embodiments, the labeling model may correspond to any one type of the classification, detection, and segmentation in common with the pre-training model described above.

According to an embodiment, the labeling model may include a convolutional neural network (CNN) structure including a plurality of convolutional layers.

Meanwhile, according to an embodiment, when the labeling model corresponds to the detection type, the labeling model may further include a bounding box regression network for inferring the bounding box coordinates of the ground truth in addition to the CNN structure.

For example, the labeling model may include an object regression network as the bounding box regression network.

Meanwhile, according to an embodiment, when the labeling model corresponds to the segmentation type, the labeling model may further include a mask training layer for predicting a mask corresponding to a polygon in addition to the CNN structure and the bounding box regression network.

For example, the labeling model may include a Mask R-CNN architecture as the mask training layer.

According to an embodiment, when a plurality of pre-training models correspond to the detection or segmentation type, the model trainer 150 may use only a part of data loaded from the storage 3 for training prior to training the labeling model.

Specifically, when the plurality of pre-training models correspond to the detection or segmentation type, the model trainer 150 may crop only the part of the data loaded from the storage 3 based on areas of bounding boxes displayed on the data used for training and use it as an input of the labeling model.

In more detail, when data is loaded from the storage 3, the model trainer 150 may load only the bounding box that overlaps the bounding box reviewed by the user among the bounding boxes displayed by each of the plurality of pre-training models on the loaded data.

If there is no bounding box that overlaps the bounding box reviewed by the user, the model trainer 150 may extend the horizontal and vertical lengths of the bounding box by preset magnification based on the center coordinates of the bounding box reviewed by the user so that the corresponding bounding box overlaps at least one of the bounding boxes displayed by each of the plurality of pre-training models.

In this case, the bounding box displayed by some pre-training models may not overlap the extended bounding box. In this case, as the predicted label value of the corresponding pre-learning model, a preset value (e.g., which may be a value that does not correspond to all classes constituting the domain in which the pre-training model is pre-trained) may be collectively allocated.

However, if the plurality of bounding boxes displayed in one pre-training model overlap the bounding box reviewed by the user, the model trainer 150 may select one bounding box from among the plurality of bounding boxes according to a preset criterion and use it for training the labeling model.

According to an embodiment, the model trainer 150 may train the labeling model by using a label set, which is composed of a predicted label and an initial review label for a part of selected unlabeled data as an initial review target, as a ground truth for the part of selected unlabeled data as the initial review target.

For example, assume that two pre-training models of the classification type are used to train the labeling model, and N-th unlabeled data selected for initial review among a plurality of unlabeled data is a satellite photo of ‘Jeju-do’.

In this case, classes of the target domain are assumed to be ‘Jeju-do, Seoul, Busan, Daejeon, Incheon, and Gangneung’, and for convenience of explanation, the classes will be referred to as ‘0, 1, 2, 3, 4, and 5’, respectively.

In addition, it is assumed that the classes in the domain in which the first pre-training model is pre-trained is a total of 257 classes, and the classes will be referred to by matching an integer from 0 to 256, respectively. Meanwhile, the classes in the domain in which the second pre-training model is pre-trained is a total of 10 classes, and the classes will be referred to by matching an integer from 0 to 9, respectively.

When the first pre-training model classifies the N-th data into class 231 among the classes of the domain in which the pre-training model is pre-trained, the second pre-training model classifies the N-th data into class 7 among the classes of the domain in which the pre-training model is pre-trained, and the user selects ‘Jeju-do’ as the initial review label for the N-th data, a label set ‘231, 7, 0’ composed of the predicted labels ‘231, 7’ and the initial review label ‘0’ for the N-th data is input as the ground truth for the N-th data.

Meanwhile, after label prediction is performed on a part of the remaining unlabeled data by the labeling model, the model trainer 150 may further train the labeling model by using the label set, which is composed of the ‘predicted label’ predicted by the plurality of pre-training models for the data on which label prediction is performed and the ‘review result’ of the user for the pseudo label predicted by the labeling model, as the ground truth to the data on which label prediction has been performed.

For example, assume that two pre-training models of the classification type are used to train the labeling model, and M-th data that has not been selected for the initial review among the plurality of unlabeled data is a satellite photo of ‘Seoul’.

For convenience of explanation, even in this case, the classes of the domain in which each pre-training model is pre-trained will be referred to by matching integers from 0 to 256 and 0 to 9, respectively.

When the first pre-training model classifies the M-th data into class 151 among the classes of the domain in which the pre-training model is pre-trained, the second pre-training model classifies the M-th data into class 4 among the classes of the domain in which the pre-training model is pre-trained, and the user selects ‘Seoul’ as the review result of the M-th data, a label set ‘151, 4, 1’ composed of the predicted labels ‘151, 4’ and the initial review label ‘1’ for the M-th data is input as the ground truth for the M-th data.

In this way, the labeling model can be iteratively trained until a review result from the user is acquired for all the remaining unlabeled data.

Regarding the learning mechanism of other labeling models, description will be made later in detail with reference to FIG. 3 below.

The predictor 160 predicts a label by applying the labeling model to a part of the remaining unlabeled data except for the part of the selected unlabeled data as the initial review target.

According to an embodiment, the predictor 160 may predict a prediction estimation label estimated to be predicted by the plurality of pre-training models and a pseudo label predicted to be input by a user for a part of the remaining unlabeled data except for the part of the selected unlabeled data for initial review.

Specifically, the data targeted for prediction by the predictor 160 may be limited to the part of the remaining unlabeled data, not all of the remaining unlabeled data except for the part of the selected unlabeled data for the initial review. This is to iteratively improve the performance of the labeling model by predicting only the part of the remaining unlabeled data to be predicted and retraining the labeling model using the result because there is a possibility that the labeling model may not be fully trained only by training using the initial review label.

In this case, the predictor 160 performs prediction on the unlabeled data as much as the preset quantity for one cycle of the labeling model, and in this case, ‘one cycle’ may correspond to a unit epoch, and the ‘preset quantity’ may correspond to a batch number.

According to an embodiment, the number of prediction estimation labels predicted by the predictor 160 may be the same as the number of a plurality of pre-training models included in the pre-training model pool 2.

According to an embodiment, the predictor 160 may output the greatest value among the confidence of each of the prediction estimation labels and the confidence of the pseudo labels, together with the prediction estimation label and the pseudo label, as the confidence (hereinafter, referred as ‘overall confidence’) of the prediction estimation label and pseudo label as a whole.

For example, when the prediction estimation label estimated by applying the labeling model to the N-th data described above by the predictor 160 is ‘0, 4’ and the pseudo label is ‘0’, the confidence will be calculated for each of the three labels, and assuming that the confidence in the pseudo label ‘0’ is the greatest at 0.89, the overall confidence for labels ‘0, 4, 0’ as a whole may be 0.89.

According to an embodiment, the predictor 160 may calculate a matching rate by comparing the degree of matching between the respective predicted labels of the plurality of pre-training models and the prediction estimation labels estimated by the predictor 160, and calculate a label score for all of the prediction estimation label and the pseudo label based on the calculated matching rate and the overall confidence described above.

Specifically, the predictor 160 may calculate a percentage of the number of prediction estimation labels that match the predicted label among the total number of prediction estimation labels as the matching rate. Thereafter, the predictor 160 may calculate a value obtained by multiplying the calculated matching rate and the overall confidence described above as the label score for all of the prediction estimation labels and the pseudo label.

According to an embodiment, the predictor 160 may provide the calculated label score to the user. In this case, the predictor 160 may provide the label score through the display 4 described above, etc., and accordingly, the user may perform a more precise review by referring to the label score when reviewing the pseudo label estimated by the labeling model.

FIG. 3 is a block diagram for describing in detail the model trainer 150 according to an embodiment.

As illustrated, the model trainer 150 according to an embodiment may include a loss calculator 151 and an optimizer 152

The loss calculator 151 may calculate a loss function value based on the output value of the labeling model for a part of data selected for an initial review target and the label set which is a ground truth to the part of the data selected for the initial review target.

According to an embodiment, the loss calculator 151 may calculate the loss function value based on a difference between the output value of the labeling model for the part of the data selected for the initial review target and the label set which is the ground truth to the part of the data selected for the initial review target.

According to an embodiment, in calculating the loss function value based on the difference between the output value of the labeling model and the label set, the loss calculator 151 may give a weight to a difference between the last value constituting the output value of the labeling model and the last value constituting the label set. This is due to the fact that the last value constituting the label set is the initial review label or review result of the user, and it is more likely to be a label that represents the characteristics of the actual data well compared to the value predicted by the pre-learning model.

For example, the loss function value may be calculated by the cross-entropy function.

The optimizer 152 may update the training parameter of the labeling model based on the calculated loss function value.

Specifically, the optimizer 152 may update the training parameter of the labeling model in a direction in which the calculated loss function value decreases.

For example, the optimizer 152 may update the training parameter of the labeling model based on a gradient descent method. In this case, the training parameter may be a weight and a bias applied to each node of a hidden layer in the labeling model.

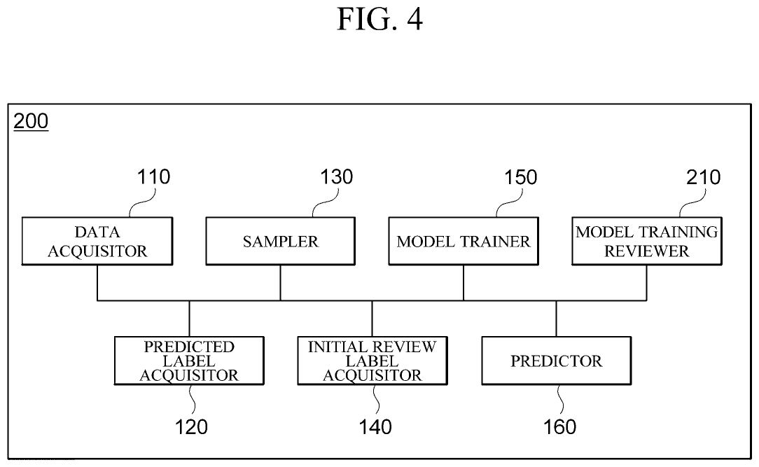

FIG. 4 is a block diagram illustrating an apparatus 200 for labeling data according to an additional embodiment.

As illustrated, the apparatus 200 for labeling data according to an additional embodiment may further include a model training reviewer 210, in addition to the data acquisitor 110, the predicted label acquisitor 120, the sampler 130, the initial review label acquisitor 140, the model trainer 150, and the predictor 160.

Among these units, the data acquisitor 110, the predicted label acquisitor 120, the sampler 130, and the initial review label acquisitor 140 perform the same or similar functions as those described above with reference to FIGS. 2 and 3, and thus a more detailed description thereof will be omitted.

The model training reviewer 210 may provide a pseudo label predicted to be input by the user for a part of the remaining unlabeled data to the user.

In addition, the model training reviewer 210 may acquire a review result for the provided pseudo label from the user.

Subsequently, the model trainer 150 may further train the labeling model by using a label set composed of the predicted label for the part of the remaining unlabeled data and the review result acquired from the model training reviewer 210 as the ground truth for the part of the remaining unlabeled data.

According to an embodiment, the labeling model may be trained until the review result is acquired for all the remaining unlabeled data.

Meanwhile, according to another embodiment, the labeling model may be trained using the remaining unlabeled data until a predetermined performance criterion represented by the confidence or label score is achieved.

For example, assume that initially, the total number of pieces of unlabeled data is 1000 and the number of pieces of the part of the unlabeled data selected for the initial review target is 100. In this case, if the number of pieces of the remaining unlabeled data is 900 and the batch number of the part of the unlabeled data used each time the labeling model is trained is 100, the labeling model may be iteratively trained over a total of nine times using the remaining unlabeled data.

In this process, the performance of the labeling model will gradually improve as the review result of the user is reflected each time the labeling model is trained and the labeling model may be trained nine times using all the remaining unlabeled data, but if the performance of the labeling model meets a preset performance criterion during training, the training may be terminated at that point in time.

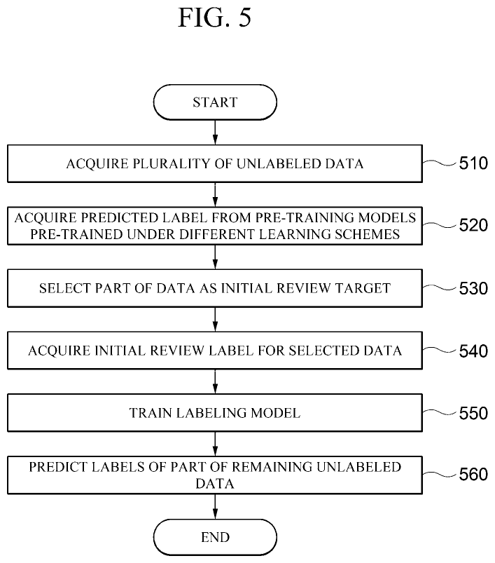

FIG. 5 is a flowchart for describing a method for labeling data according to an embodiment.

The method illustrated in FIG. 5 may be performed, for example, by the apparatus 100 for labeling data described above.

First, the apparatus 100 for labeling data acquires a plurality of unlabeled data (510).

Thereafter, the apparatus 100 for labeling data acquires a predicted label for the unlabeled data from a plurality of pre-training models pre-trained under different learning schemes (520).

Thereafter, the apparatus 100 for labeling data selects a part of the unlabeled data as an initial review target (530).

Thereafter, the apparatus 100 for labeling data acquires an initial review label for the part of the unlabeled data from the user (540).

Thereafter, the apparatus 100 for labeling data trains a labeling model based on the part of the unlabeled data, a predicted label for the part of the unlabeled da, and the initial review label (550).

Thereafter, the apparatus 100 for labeling data predicts labels of the part of the remaining unlabeled data by applying the labeling model to the part of the remaining unlabeled data except for the part of the unlabeled data (560).

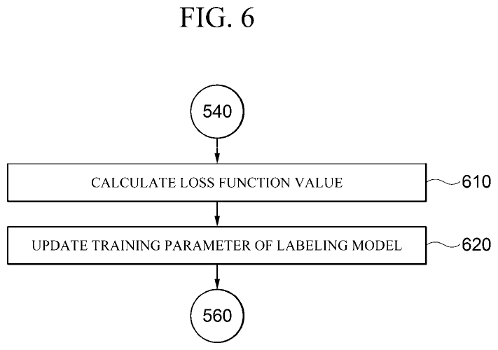

FIG. 6 is a flowchart for describing in detail step 550 according to an embodiment.

The method illustrated in FIG. 6 may be performed, for example, by the apparatus 100 for labeling data described above.

First, the apparatus 100 for labeling data calculates the loss function value based on the output value of the labeling model for the part of the unlabeled data selected as an initial review target, and the label set composed of the predicted label and the initial review label for the corresponding part of the unlabeled data (610).

Thereafter, the apparatus 100 for labeling data updates the training parameter of the labeling model based on the calculated loss function value (620).

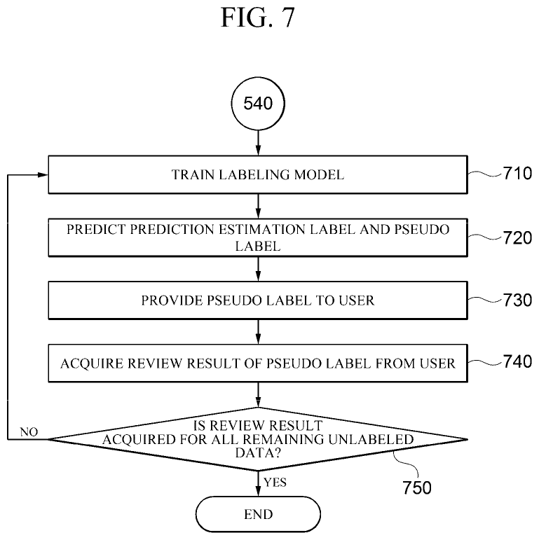

FIG. 7 is a flowchart illustrating a method for labeling data according to an additional embodiment. It is assumed that steps 510 to 540 in the embodiment described with reference to FIG. 5 are performed prior to performing steps 710 to 750 below.

The method illustrated in FIG. 7 may be performed, for example, by the apparatus 200 for labeling data described above.

First, the apparatus 100 for labeling data trains the labeling model based on the part of the unlabeled data selected as the initial review target, the predicted label for the corresponding part of the unlabeled data, and the initial review label (710).

Thereafter, the apparatus 100 for labeling data predicts the prediction estimation label estimated to be predicted by the plurality of pre-training models and the pseudo label predicted to be input by a user for some of the remaining unlabeled data except for the part of the unlabeled data selected for the initial review target (720).

Thereafter, the apparatus 100 for labeling data provides the predicted pseudo label to the user (730).

Thereafter, the apparatus 100 for labeling data acquires the review result of the predicted pseudo label from the user (740).

Thereafter, the apparatus 100 for labeling data determines whether the review result is acquired from the user for all the remaining unlabeled data (750).

Thereafter, when it is determined that data for which the review result has not been acquired exists among the remaining unlabeled data, the apparatus 100 for labeling data further trains the labeling model by using the label set composed of the predicted label and the review result for the corresponding data as the ground truth to the corresponding data.

Meanwhile, when it is determined that the apparatus 100 for labeling data has acquired the review result for all the remaining unlabeled data, the data labeling apparatus 100 ends training of the labeling model.

In FIGS. 5 to 7 described above, the method is described by being divided into a plurality of steps, but at least some of the steps may be performed in a different order, performed together by being combined with other steps, omitted, performed by being divided into detailed steps, or performed by being added with one or more steps (not illustrated).

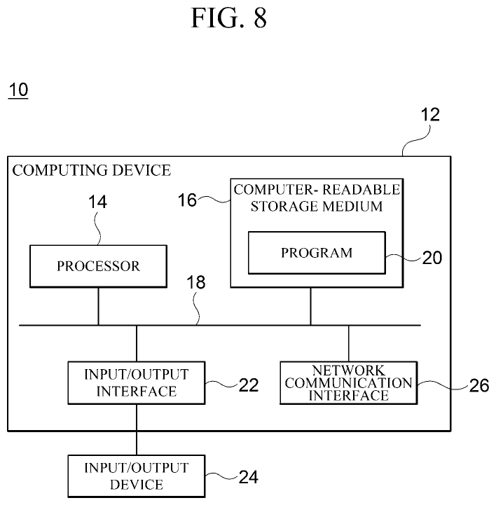

FIG. 8 is a block diagram for illustratively describing a computing environment 10 that includes a computing device according to an embodiment. In the illustrated embodiment, each component may have different functions and capabilities in addition to those described below, and additional components may be included in addition to those described below.

The illustrated computing environment 10 includes a computing device 12. In an embodiment, the computing device 12 may be the apparatus 100 for labeling data. In addition, the computing device 12 may be the apparatus 200 for labeling data according to an additional embodiment

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

According to the disclosed embodiments, accurate labels can be quickly acquired for unlabeled data by training the labeling model using the labels predicted by several pre-training models trained under different learning systems and the review result of the user.

According to disclosed embodiments, initially, a part of data is selected as a review target by the user, and the label predicted by the labeling model is reviewed by the user once more, and thus training of the labeling model rapidly converges toward the desired performance.

Meanwhile, the embodiment of the present invention may include a program for performing the methods described in this specification on a computer, and a computer-readable recording medium containing the program. The computer-readable recording medium may contain program instructions, local data files, local data structures, etc., alone or in combination. The computer-readable recording medium may be specially designed and configured for the present invention, or may be commonly used in the field of computer software. Examples of computer-readable recording media include magnetic media such as a hard disk, a floppy disk, and a magnetic tape, optical recording media such as a CD-ROM and a DVD, and hardware devices such as a ROM, a RAM, a flash memory, etc., that are specially configured to store and execute program instructions are included. Examples of the program may include a high-level language code that can be executed by a computer using an interpreter, etc., as well as a machine language code generated by a compiler.

Although the present invention has been described in detail through representative examples above, those skilled in the art to which the present invention pertains will understand that various modifications may be made thereto within the limit that do not depart from the scope of the present invention. Therefore, the scope of rights of the present invention should not be limited to the described embodiments, but should be defined not only by claims set forth below but also by equivalents of the claims.

What is claimed is:

1. A method for labeling data performed by a computing device including one or more processors and a memory for storing one or more programs executed by the one or more processors, the method comprising:
acquiring a plurality of unlabeled data;
acquiring predicted labels for the unlabeled data from a plurality of pre-training models pre-trained under different learning schemes;
selecting a part of the unlabeled data as an initial review target;
acquiring an initial review label for the part of the unlabeled data from a user;
training a labeling model based on the part of the unlabeled data, predicted labels for the part of the unlabeled data, and the initial review label; and
predicting labels of a part of the remaining unlabeled data excluding the part of the unlabeled data by applying the labeling model to the part of the remaining unlabeled data.

2. The method for labeling data of claim 1, wherein the learning schemes include at least one of domains in which the plurality of pre-training models are pre-trained and network structures of the plurality of pre-training models.

3. The method for labeling data of claim 1, wherein, in the selecting, the part of the unlabeled data is selected as the initial review target based on the predicted labels for the unlabeled data and a confidence corresponding to the predicted labels for the unlabeled data.

4. The method for labeling data of claim 1, wherein, in the training the labeling model, the labeling model is trained by using a label set composed of the predicted labels for the part of the unlabeled data and the initial review label as a ground truth for the part of the unlabeled data.

5. The method for labeling data of claim 4, wherein the training the labeling model comprises:
calculating a loss function value based on an output value of the labeling model for the part of the unlabeled data and the label set; and
updating one or more training parameters of the labeling model based on the loss function value.

6. The method for labeling data of claim 1, wherein, in the predicting, for the part of the remaining unlabeled data, a prediction estimation label estimated to have been predicted by the plurality of pre-training models and a pseudo label predicted to be input by the user is predicted.

7. The method for labeling data of claim 1, further comprising:
providing a pseudo label predicted to be input by the user for the part of the remaining unlabeled data to the user; and
acquiring a review result for the pseudo label from the user.

8. The method for labeling data of claim 7, wherein, in the training the labeling model, the labeling model is further trained by using a label set composed of the predicted label for the part of the remaining unlabeled data and the review result as a ground truth for the part of the remaining unlabeled data.

9. The method for labeling data of claim 8, wherein the labeling model is trained until the review result is acquired for all the remaining unlabeled data.

10. The method for labeling data of claim 1, wherein the types of the plurality of pre-training models and the labeling model correspond to any one type in common among classification, detection, and segmentation.

11. An apparatus for labeling data comprising:
a data acquisitor that acquires a plurality of unlabeled data;
a predicted label acquisitor that acquires predicted labels for the unlabeled data from a plurality of pre-training models pre-trained under different learning schemes;
a sampler that selects a part of the unlabeled data as an initial review target;
an initial review label acquisitor that acquires an initial review label for the part of the unlabeled data from a user;
a model trainer that trains a labeling model based on the part of the unlabeled data, predicted labels for the part of the unlabeled data, and the initial review label; and
a predictor that predicts labels of a part of the remaining unlabeled data excluding the part of the unlabeled data by applying the labeling model to the part of the remaining unlabeled data.

12. The apparatus for labeling data of claim 11, wherein the learning schemes include at least one of domains in which the plurality of pre-training models are pre-trained and network structures of the plurality of pre-training models.

13. The apparatus for labeling data of claim 11, wherein the sampler selects the part of the unlabeled data as the initial review target based on the predicted labels for the unlabeled data and a confidence corresponding to the predicted label for the unlabeled data.

14. The apparatus for labeling data of claim 11, wherein the model trainer trains the labeling by using a label set composed of the predicted labels for the part of the unlabeled data and the initial review label as a ground truth for the part of the unlabeled data.

15. The apparatus for labeling data of claim 14, wherein the model trainer comprises:
a loss calculator that calculates a loss function value based on an output value of the labeling model for the part of unlabeled data and the label set; and
an optimizer that updates one or more training parameters of the labeling model based on the loss function value.

16. The apparatus for labeling data of claim 11, wherein the predictor, for the part of the remaining unlabeled data, predicts a prediction estimation label estimated to have been predicted by the plurality of pre-training models and a pseudo label predicted to be input by the user.

17. The apparatus for labeling data of claim 11, further comprising:
a model training reviewer that provides a pseudo label predicted to be input by the user for the part of the remaining unlabeled data to the user, and acquires a review result for the pseudo label from the user.

18. The apparatus for labeling data of claim 17, wherein the model training further trains the labeling model by using a label set composed of the predicted label for the part of the remaining unlabeled data and the review result as a ground truth for the part of the remaining unlabeled data.

19. The apparatus for labeling data of claim 18, wherein the labeling model is trained until the review result is acquired for all the remaining unlabeled data.

20. The apparatus for labeling data of claim 11, wherein the types of the plurality of pre-training models and the labeling model correspond to any one type in common among classification, detection, and segmentation.
